(19) United States
(12) Patent Application Publication
(10) Pub. No.: US 2014/0104906 A1
(43) Pub. Date: Apr. 17, 2014

(54) ENERGY STORAGE DEVICE, AND SYSTEM HAVING AN ENERGY STORAGE DEVICE

(71) Applicant: ROBERT BOSCH GMBH, Stuttgart (DE)

(72) Inventor: Peter Feuerstack, Ludwigsburg (DE)

(73) Assignee: ROBERT BOSCH GMBH, Stuttgart (DE)

(21) Appl. No.: 14/122,352

(22) PCT Filed: Apr. 3, 2012
(86) PCT No.: PCT/EP12/56015

§ 371 Date: Jan. 2, 2014

(30) Foreign Application Priority Data
May 26, 2011 (DE) 10 2011 076 515.8

(51) Int. Cl. H02M 7/5387

(52) U.S. Cl. CPC H02M 7/53871
USPC 363/71

(57) ABSTRACT

The invention relates to an energy storage device (1) for generating an n-phase supply voltage, where n≧1, with n energy supply branches which are connected in parallel and which are each connected to one of n phase connections, wherein each of the energy supply branches has a large number of energy storage modules (3) which are connected in series and which each comprise: an energy storage cell module (5) which has at least one energy storage cell (1a, 5n), and a coupling device (9) with coupling elements (7, 8) which are designed to switch or to bridge the energy storage cell module (5) selectively into the respective energy supply branch, wherein those coupling elements (8) of the coupling devices (9) which are designed to bridge the energy storage cell module (5) in the respective energy supply branch comprise normally-on semiconductor switches (8a). The other coupling elements (7) can comprise normally-off semiconductor switches (7a) in this case.

### BACKGROUND OF THE INVENTION

The invention relates to an energy storage device, and a system having an energy storage device, in particular in a battery direct converter circuit for supplying power to electric machines.

The trend is that in the future electronic systems which combine new energy storage technologies with electrical drive technology will be used increasingly both in stationary applications, such as e.g. wind power installations or solar installations, and in vehicles, such as hybrid or electric vehicles.

FIG. 1, for example, shows the feed of alternating current into a three-phase electric machine 101. In this case, a DC voltage provided by a DC voltage intermediate circuit 103 is converted into a three-phase AC voltage by means of a converter in the form of a pulse-controlled inverter 102. The DC voltage intermediate circuit 103 is fed by a line 104 of battery modules 105 connected in series. In order to be able to meet the requirements for power and energy provided for a respective application, often a plurality of battery modules 105 are connected in series in a traction battery 104.

The series circuit comprising a plurality of battery modules is associated with the problem that the entire line fails if a single battery module fails. Such a failure of the energy supply line can result in failure of the entire system. Furthermore, temporarily or permanently occurring power reductions of an individual battery module can result in power reductions in the entire energy supply line.

The document U.S. Pat. No. 5,642,275 A1 describes a battery system with an integrated inverter function. Systems of this type are known under the name Multilevel Cascaded Inverter or else Battery Direct Inverter (BDI). Such systems comprise DC sources in a plurality of energy storage module lines, which can be connected directly to an electric machine or an electrical power supply system. In this case, single-phase or polyphase supply voltages can be generated. The energy storage module lines in this case have a plurality of energy storage modules which are connected in series, wherein each energy storage module has at least one battery cell and an assigned controllable coupling unit, which makes it possible to interrupt the respective energy storage module line or to bridge the respectively assigned at least one battery cell or to switch the respectively assigned at least one battery cell into the respective energy storage module line, depending on control signals. By suitable driving of the coupling units, for example with the aid of pulse width modulation, suitable phase signals for controlling the phase output voltage can also be provided, with the result that a separate pulse-controlled inverter can be dispensed with. The pulse-controlled inverter required for controlling the phase output voltage is thus integrated into the BDI, as it were.

BDIs usually have a higher efficiency and a higher degree of failsafety in comparison with conventional systems, as shown in FIG. 1. The failsafety is ensured, inter alia, by virtue of the fact that defective, failed or not fully effective battery cells can be disconnected from the energy supply lines by suitable bridging driving of the coupling units.

The energy for controlling the coupling units is usually provided by the battery cells within the energy storage module itself. In the case of de-energized battery cells, for example in the case of defective or fully discharged battery cells, therefore, under certain circumstances the situation can occur that the coupling units can no longer be driven owing to lack of operating voltage. In these cases, suitable bridging driving of the coupling units is no longer possible and the entire energy supply line fails.

### SUMMARY OF THE INVENTION

In accordance with one embodiment, the present invention provides an energy storage device for generating an n-phase supply voltage, wherein n≧1, comprising n energy supply branches which are connected in parallel and which are each connected to one of n phase connections, wherein each of the energy supply branches has a large number of energy storage modules which are connected in series and which each comprise an energy storage cell module having at least one energy storage cell, and a coupling device having coupling elements which are designed to switch or to bridge the energy storage cell module selectively into the respective energy supply branch. In this case, those coupling elements of the coupling devices which are designed to bridge the energy storage cell module in the respective energy supply branch comprise normally on semiconductor switches.

In accordance with a further embodiment, the present invention provides a system comprising an n-phase electric machine, wherein n≧1, an energy storage device according to the invention, the phase connections of which are connected to the phase lines of the electric machine, and a control device which is designed to selectively drive the coupling devices of the energy storage modules for generating a supply voltage for the electric machine.

One concept of the present invention is to increase the fail safety of battery direct inverters even further by providing coupling elements at critical locations in a corresponding energy storage device, which coupling elements automatically establish a bridging switching state of the associated energy storage cell modules in the de-energized state. As a result, even in the event of complete failure of the supply voltage of the coupling elements, reliable bridging of defective energy storage cell modules is ensured, such that the energy storage device can continue to be operated in any case even when individual energy storage cell modules fail.

In accordance with one advantageous embodiment, an energy storage device can have as coupling elements semiconductor switches, for example MOSFET switches, which are normally on or normally off depending on the position in the switching chain. For coupling elements which are switched on in a bridging state of the associated energy storage cell module, normally on semiconductor switches can be provided, for example, which automatically establish the bridging state in the de-energized state. For other coupling elements, which are switched off or at least need not be switched on in a bridging state of the associated energy storage cell module, it is advantageously possible, by contrast, to use normally off semiconductor switches.

In accordance with one advantageous embodiment, the coupling devices can be realized in each case in a full-bridge circuit or in a half-bridge circuit, depending on the application. If, by way of example, a reversal of the polarity of the energy storage cell modules in the energy supply branches is desired, the coupling devices can be configured in a full-bridge circuit having four coupling elements in each case. In this case, by way of example, two of the coupling elements can respectively be designed as normally on semiconductor switches, and the other two coupling elements as normally off semiconductor switches. If a reversal of the polarity of the energy storage cell modules is not desired or necessary, the coupling devices can be configured in a half-bridge circuit having two coupling elements in each case. In this case, by way of example, one of the two coupling elements can respectively be designed as a normally on semiconductor switch, and the other coupling element as a normally off semiconductor switch.

### BRIEF DESCRIPTION OF THE DRAWINGS

Further features and advantages of embodiments of the invention will become apparent from the following description with reference to the accompanying drawings.

In the figures:

FIG. 1 shows a schematic illustration of a voltage supply system for a three-phase electric machine,

FIG. 2 shows a schematic illustration of a system comprising an energy storage device in accordance with one embodiment of the present invention,

FIG. 3 shows a schematic illustration of the construction of an energy storage module of an energy storage device in accordance with a further embodiment of the present invention, and

FIG. 4 shows a schematic illustration of the construction of an energy storage module of an energy storage device in accordance with yet another embodiment of the present invention.

### DETAILED DESCRIPTION

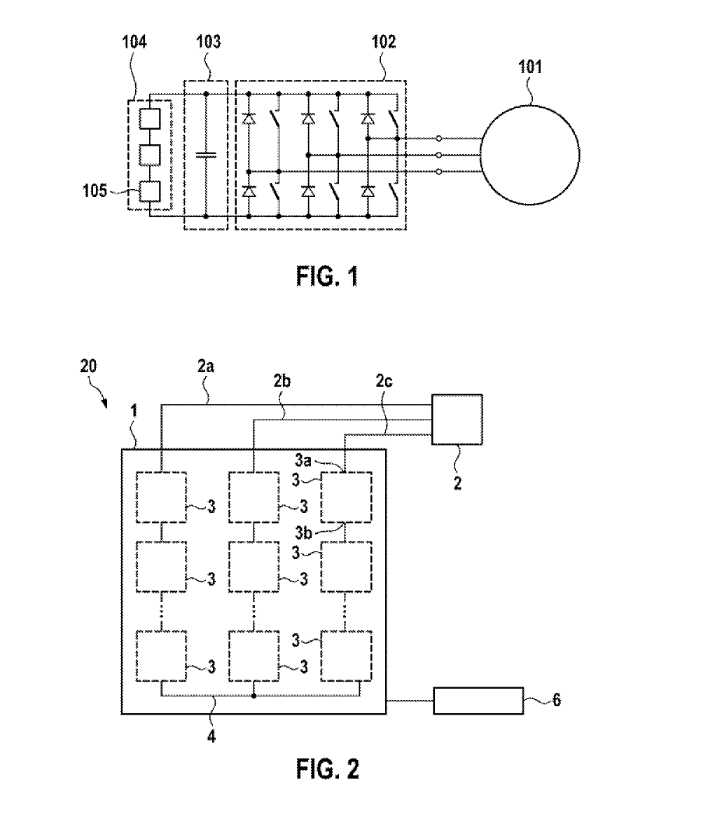

FIG. 2 shows a system 20 for the voltage conversion of DC voltage provided by energy storage modules 3 into an n-phase AC voltage. The system 20 comprises an energy storage device 1 comprising energy storage modules 3 connected in series in energy supply branches. Three energy supply branches are shown by way of example in FIG. 2, which are suitable for generating a three-phase AC voltage, for example for a three-phase machine 2. However, it is clear that any other number of energy supply branches can likewise be possible. At each energy supply branch, the energy storage device 1 has an output connection, which are respectively connected to phase lines 2a, 2b, 2c. By way of example, the system 20 in FIG. 2 serves for feeding an electric machine 2. However, provision can also be made for the energy storage device 1 to be used for generating electric current for an energy supply system 2.

The system 20 can furthermore comprise a control device 6, which is connected to the energy storage device 1 and with the aid of which the energy storage device 1 can be controlled in order to provide the desired output voltages at the respective phase connections 2a, 2b, 2c.

The energy supply branches can be connected at their end to a reference potential 4 (reference rail), which, in the embodiment illustrated, carries a mid potential with respect to the phase lines 2a, 2b, 2c of the electric machine 2. The reference potential 4 can be a ground potential, for example. Each of the energy supply branches has at least two energy storage modules 3 connected in series. By way of example, the number of energy storage modules 3 per energy supply branch is three in FIG. 2, but any other number of energy storage modules 3 is likewise possible. Preferably, in this case each of the energy supply branches comprises the same number of energy storage modules 3, but it is also possible to provide a different number of energy storage modules 3 for each energy supply branch.

The energy storage modules 3 each have two output connections 3a and 3b, via which an output voltage of the energy storage modules 3 can be provided.

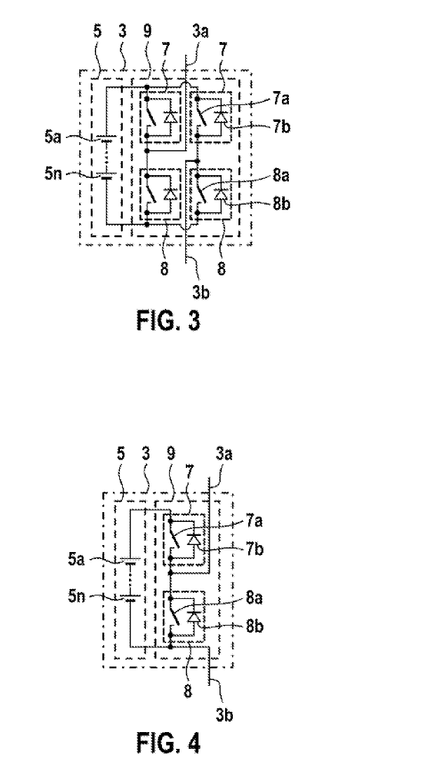

An exemplary construction of the energy storage modules 3 is shown in greater detail in FIG. 3. The energy storage modules 3 each comprise a coupling device 9 having a plurality of coupling elements 7 and 8. Furthermore, the energy storage modules 3 each comprise an energy storage cell module 5 having one or a plurality of energy storage cells 5a, 5n connected in series.

In this case, the energy storage cell module 5 can have, for example, series-connected batteries 5a, 5n, for example lithium-ion batteries. In this case, the number of energy storage cells 5a, 5n in the energy storage module shown in FIG. 2 is two, for example, but any other number of energy storage cells 5a, 5n is likewise possible. In other embodiments, the energy storage cells 5a, 5n can also comprise photovoltaic modules, for example.

The energy storage cell modules 5 are connected to input connections of the associated coupling device 9 via connecting lines. The coupling device 9 in FIG. 3 is designed, by way of example, as a full-bridge circuit having in each case two coupling elements 7 and two coupling elements 8. In this case, the coupling elements 7 can each have an active switching element 7a, for example a semiconductor switch 7a, and a freewheeling diode 7b connected in parallel therewith. In a similar manner, in this case, the coupling elements 8 can each have an active switching element 8a, for example a semiconductor switch 8a, and a freewheeling diode 8b connected in parallel therewith. The semiconductor switches 7a and 8a can comprise field effect transistors (FETs), for example. In this case, the freewheeling diodes 7b and 8b can also respectively be integrated into the semiconductor switches 7a and 8a.

The coupling elements 7 and 8 in FIG. 3 can be driven in such a way, for example with the aid of the control device 6 in FIG. 2, that the energy storage cell module 5 is selectively switched between the output connections 3a and 3b or that the energy storage cell module 5 is bridged. By way of example, the energy storage cell module 5 can be switched in the forward direction between the output connections 3a and 3b by virtue of the active switching element 8a at the bottom right and the active switching element 7a at the top left being set to a closed state, while the other two active switching elements are set to an open state. A bridging state can be established, for example, by virtue of the two active switching elements 8a being set to the closed state, while the two active switching elements 7a are held in the open state.

By means of suitable driving of the coupling devices 9, therefore, individual energy storage cell modules 5 of the energy storage modules 3 can be integrated into the series circuit of an energy supply branch in a targeted manner.

In this case, the active switching elements 7a, 8a obtain their operating voltage from the energy storage cells 5a, 5n. If the situation then occurs that energy storage cells 5a, 5n are defective or fully discharged, the active switching elements 7a, 8a are no longer supplied with sufficient operating voltage to be able to carry out switching processes. In this case, it is desirable that the defective energy storage cell module 5 in the energy supply branch can be bridged in order to maintain the operating capability of the entire line. The active switching elements 8a which have to be set to a closed state in order to produce a bridging state are therefore designed as normally on semiconductor switches. Normally on semiconductor switches are characterized precisely by the fact that in the event of a failure of the operating voltage, the quiescent state is a closed state of the semiconductor switch. Therefore, if the operating voltage of the active switching elements 8a fails, the coupling device 9 is automatically set to a bridging state.

The respective other active switching elements 7a, which must not or need not be in a closed state for establishing a bridging state, can preferably be designed as normally off semiconductor switches. In the event of a failure of the operating voltage, the active switching elements 7a are then automatically in an open state. In this way, it can be ensured that, in the event of a defect or failure of the energy storage cells 5a, 5n of an energy storage cell module 5, a safe switching state of the coupling device 9 is always established automatically. Thus, even in the event of a failure of individual energy storage cells 5a, 5n, the energy storage device 1 can continue to be operated without power contribution of the detective energy storage cells. Furthermore, charging of the affected energy storage module 3 becomes possible.

FIG. 4 shows a further exemplary embodiment of an energy storage module 3. The energy storage module 3 shown in FIG. 4 differs from the energy storage module 3 shown in FIG. 3 merely in that the coupling device 9 has two instead of four coupling elements 7, 8, which are connected in a half-bridge circuit instead of in a full-bridge circuit. For the coupling device 9 shown in FIG. 4, the active switching element 8a which has to be closed for a bridging state of the coupling device 9 is a normally on semiconductor switch, and the active switching element 7a is a normally off semiconductor switch.

In the embodiment variants illustrated, the active switching elements 7a and 8a or the coupling elements 7 and 8 can be embodied as power semiconductor switches, for example in the form of IGBTs (Insulated Gate Bipolar Transistors), JFETs (Junction Field-Effect Transistors) or as MOSFETs (Metal Oxide Semiconductor Field-Effect Transistors). In this case, of course, consideration should be given to ensuring that the power semiconductor switches used have the corresponding normally on or normally off characteristics. By way of example, the normally on semiconductor switches in FIGS. 3 and 4 can be embodied as JFETs, or IGBTs or silicon MOSFETs of the depletion type. The normally off semiconductor switches in FIGS. 3 and 4 can be embodied, for example, as IGBTs or silicon MOSFETs of the enhancement type.

1. An energy storage device (1) for generating an n-phase supply voltage, wherein n≧1, comprising:
n energy supply branches which are connected in parallel and which are each connected to one of n phase connections (2a, 2b, 2c), wherein each of the energy supply branches has a large number of energy storage modules (3) which are connected in series and which each comprise:
an energy storage cell module (5) having at least one energy storage cell (5a, 5n), and
a coupling device (9) having coupling elements (7, 8) which are designed to switch or to bridge the energy storage cell module (5) selectively into the respective energy supply branch,
wherein the coupling elements (8) of the coupling devices (9) which are designed to bridge the energy storage cell module (5) in the respective energy supply branch comprise normally on semiconductor switches (8a).

2. The energy storage device (1) as claimed in claim 1, wherein the other coupling elements (7) of the coupling devices (9) comprise normally off semiconductor switches (7a).

3. The energy storage device (1) as claimed in claim 1, wherein the coupling devices (9) comprise coupling elements (7, 8) in a full-bridge circuit.

4. The energy storage device (1) as claimed in either of claim 1, wherein the coupling devices (9) comprise coupling elements (7, 8) in a half-bridge circuit.

5. A system, comprising:
an n-phase electric machine (2), wherein n≧1;
an energy storage device (1) as claimed in claim 1, the phase connections (2a, 2b, 2c) of which are connected to the phase lines of the electric machine (2); and
a control device (6) which is designed to selectively drive the coupling devices (9) of the energy storage modules (3) for generating a supply voltage for the electric machine (2).
